(19) United States
(12) Patent Application Publication
(10) Pub. No.: US 2020/0158271 A1
(43) Pub. Date: May 21, 2020

(54) JOINING PIECE COMPRISING TWO PARTS FITTED ONE INSIDE THE OTHER AND ASSEMBLED TOGETHER, AND ASSOCIATED MANUFACTURING METHOD

(71) Applicants: PIPO MOTEURS, Guilherand-Granges (FR); POLY-SHAPE, Saint Pierre Du Perray (FR)

(72) Inventors: Jean RIVOIRE, Saint Paul Les Romans (FR); Frederic IMPELLIZZERI, Salon De Provence (FR); Frederic BAROZIER, Soyons (FR)

(21) Appl. No.: 16/681,160

(22) Filed: Nov. 12, 2019

(30) Foreign Application Priority Data
Nov. 16, 2018 (FR) 1860584
Oct. 10, 2019 (FR) 1911316

(51) Int. Cl. F16L 27/04

(52) U.S. Cl. CPC F16L 27/04

(57) ABSTRACT

Joining piece that includes two parts fitted one inside the other and assembled together, and associated manufacturing method. The joining piece is for producing a mechanical joint between two elements, and includes a female part including a mechanical assembly portion and a receiving portion continuing on from the assembly portion, with the receiving portion being in the shape of an equatorial section of a sphere, and a male part including a mechanical assembly portion and an insertion portion continuing on from the assembly portion, the insertion portion being in the shape of an equatorial section of a sphere, inserted with clearance into the receiving portion and being retained in it, so that the male part is rotatably mobile in one or more degrees of freedom relative to the female part while being mechanically assembled with it.

### TECHNICAL FIELD

The present invention relates to the field of mechanical joining pieces used to connect two elements.

The invention aims more particularly to propose a joining piece for producing a mechanical joint, preferably a ball joint, between two elements capable of undergoing differential movements, while permitting the passage of a fluid through the joining piece.

The joining piece must thus allow a certain degree of movement between the two elements that it connects, with the aim of preventing the occurrence of undesirable mechanical stresses and ensuring a satisfactory degree of reliability and sealing.

According to another of its aspects, the invention also relates to a method for manufacturing this joining piece.

The main application envisaged by the invention relates to a ball joint arranged in an exhaust gas circuit at the outlet of a combustion engine in a motor vehicle, for example at the outlet or inlet of a turbocharger or at the outlet of a turbocharger wastegate.

Although it is described with reference to the main application, the invention applies to any system, mechanism, accessory, device, machine, etc. in which there is a need for a reliable, sealed joint allowing degrees of freedom of rotation in one or more directions.

“Ball joint” is given to mean a mechanical joint that permits freely rotating movements in any direction but no significant translational movement.

### PRIOR ART

A motor vehicle engine, in particular a competition vehicle internal combustion engine, is subject to impacts and vibrations that can be particularly significant.

As a result, it is common, particularly in the context of tuning vehicles for competition, to insert between the motor and the chassis parts made from a flexible material, such as polyurethane.

The aim of these shock absorbing parts, usually called “silent blocks”, is to absorb the impacts, noises and vibrations and thus prevent them from being transmitted to the chassis of the vehicle.

As a result of this shock absorption, differential movement between the engine and the chassis is inevitable.

This differential movement necessarily results in undesirable mechanical stresses between the exhaust gas manifold located at the engine outlet, the turbocharger turbine casing located after the exhaust manifold and finally, the exhaust line.

Furthermore, high levels of thermal stress due to the high temperature of the gases leaving the engine are applied to these different elements, in addition to the mechanical stresses.

As a result, and as the inventors have noted, the combination of these factors can lead to the occurrence of significant damage to or even breakage of either the exhaust manifold and/or the turbocharger, or the exhaust line.

These breakages, which can be recurrent, cause a fire risk on the motor vehicle.

The existing solutions to this technical problem are not entirely satisfactory.

These solutions include slide mechanisms implementing a guide part to limit the mechanical stresses.

Flexible joining elements, such as braided hoses and corrugated hoses, are also known and used in this context.

Finally, there are simple ball joint systems that make it possible to achieve release of the mechanical stresses.

However, none of the existing solutions has reached a sufficient degree of reliability and/or sealing, while permitting rotational stress release in one or more directions.

There is therefore a need to improve the mechanical joints at the engine outlet, in the exhaust gas circuit of a motor vehicle, particularly to overcome the drawbacks of the existing solutions.

More generally, there is a need for mechanical joints between two elements that allow degrees of freedom of rotation in one or more directions, while ensuring high levels of reliability and sealing.

The aim of the invention is to at least partially meet these needs.

### DISCLOSURE OF THE INVENTION

To do this, according to a first alternative, the invention relates to a joining piece for producing a mechanical joint between two elements, comprising:
a female part comprising a portion for mechanical assembly with a first element separate from the part, and a receiving portion continuing on from the mechanical assembly portion, the receiving portion comprising a single shell in the shape of an equatorial section of a sphere,
a male part comprising a portion for mechanical assembly with a second element separate from the part, and an insertion portion continuing on from the mechanical assembly portion, the insertion portion being in the shape of an equatorial section of a sphere, inserted with clearance into the shell of the receiving portion and being retained in it, so that the male part is rotatably mobile in one or more degrees of freedom relative to the female part while being mechanically assembled with it.

According to a second alternative, the joining piece for producing a mechanical joint between two elements comprises:
a female part comprising a portion for mechanical assembly with a first element separate from the part, and a receiving portion continuing on from the mechanical assembly portion, the receiving portion comprising two shells each in the shape of an equatorial section of a sphere, the two equatorial sections of a sphere being concentric and separated by a free space,
a male part comprising a portion for mechanical assembly with a second element separate from the part, and an insertion portion continuing on from the mechanical assembly portion, the insertion portion being in the shape of an equatorial section of a sphere, inserted with clearance into the free space of the receiving portion and being retained in it, so that the male part is rotatably mobile in one or more degrees of freedom relative to the female part while being mechanically assembled with it.

According to a particular embodiment, one of the receiving portion and the insertion portion also includes a slot, the other of the receiving portion and the insertion portion includes a pin inserted into the slot, the slot and the pin being configured so that the male part is rotatably mobile in two degrees of freedom relative to the female part.

The slot can be a through-slot or otherwise.

Alternatively, one of the receiving portion and the insertion portion also includes a slot, the other of the receiving portion and the insertion portion includes a tab that is shorter than the slot and inserted into the slot, the slot and the tab being configured so that the male part is rotatably mobile in one degree of freedom relative to the female part.

The invention thus essentially consists of a mechanical joining piece comprising two parts fitted one inside the other in such a way as to permit one or more degrees of freedom of rotation relative to each other, while being assembled together without any additional component or means.

The invention makes it possible to eliminate, simply and reliably, the mechanical stresses that occur between two elements to be connected that are capable of undergoing uncontrolled differential movements, for example between a combustion engine, a turbocharger and an exhaust line in a motor vehicle.

The mechanical assembly of the joining piece according to the invention with the two external elements can be carried out by welding, bonding (depending on the materials used) or flanging.

Preferably, the amplitude of movement, or “swivel angle” between the female part and the male part, defined by the angle of inclination between the axis of symmetry of the receiving portion and the axis of symmetry of the insertion portion, can be between 0° and 20°, preferably between 0° and 10°.

According to a particular embodiment, the mechanical assembly portions of the female part and the male part respectively are cylindrical portions, but these portions are not limited to this geometry and can be of different types. Thus, according to an alternative embodiment, the mechanical assembly portions are truncated conical portions.

Preferably, the cylindrical portions have identical outer diameters.

According to an advantageous embodiment, the male and female parts are open-ended, so that a fluid can circulate inside the joining piece, from one of the mechanical assembly portions towards the other. The joining piece according to the invention can thus be used in a fluid circuit, for example to permit the exhaust gases from an internal combustion engine to circulate in the circuit.

The design of the joining piece according to the invention ensures the dynamic sealing of a flow of gas inside it. The inventors have noted the absence of gas leaks to the outside, through the clearance between the shell on the one hand and the insertion portion on the other, or, if applicable, through the free space of the female ball joint part. This can be explained by the dynamics of the flow of the fluid through the joining piece.

According to a first variant, the cylindrical portions have identical inner diameters. The joining piece can thus be placed in series in a fluid circuit in which a single flow of gas circulates. The joining piece thus acts to a certain extent like a universal joint with internal fluid circulation, between two elements. This can be for example a universal joint type connection between a turbocharger and an exhaust line of an internal combustion engine.

According to a second variant, the cylindrical portions have different inner diameters. The joining piece is thus suitable for connecting in parallel two portions of a fluid circuit with either convergent or divergent cross-sections. This parallel connection can be advantageous for dual fluid lines. This can be for example a connection between the turbocharger outlet and a wastegate outlet.

Advantageously, the material(s) forming the male part and the female part is/are suitable for withstanding temperatures of between −50° C. and 1,100° C., and in particular, up to 1,050° C. Depending on the application envisaged, and particularly depending on the fluid circulating through the joining piece and the temperature and pressure stresses, any type of material suitable for additive manufacturing can be envisaged.

Preferably, the material(s) forming the male part and/or the female part is/are selected from any type of weldable material, such as a nickel-based alloy such as Inconel® 625 or a stainless steel. It can be envisaged that the male part and the female part are made from the same material(s), or that the male part and the female part are made from different materials.

According to an advantageous embodiment of the second alternative of the invention according to which the female part comprises two shells, the joining piece comprises one or more through-orifices from the outside into the free space. A Venturi effect can thus be obtained in the free space and thereby further improve the sealing of the gases circulating through the joining piece according to the invention.

According to a variant embodiment, when mechanical assembly by screwing the piece to at least one of the two external elements is envisaged, one and/or the other of the portions for mechanical assembly to the first and second element can incorporate a coupling flange.

The invention also relates to a method for manufacturing a joining piece as described above, according to which the female ball joint part and the male ball joint part are produced and mechanically assembled together in a single step by additive manufacturing.

Due to the spherical geometry of the insertion and receiving portions, it is not possible to insert the male part into the female part and assemble them simultaneously, if the two parts are manufactured separately.

As a result, only an additive manufacturing method makes it possible to obtain the male and female parts of the joining piece according to the invention.

Of course, if one or the other of the mechanical assembly portions incorporates a coupling flange, then this can also be incorporated during additive manufacturing or alternatively added on by welding or soldering.

The present invention also relates to the use of a joining piece as described above in an exhaust gas circuit at the outlet of an internal combustion engine, particularly of a motor vehicle, and/or at the inlet of a motor vehicle turbocharger.

### BRIEF DESCRIPTION OF THE DRAWINGS

FIG. 1 is a diagrammatic longitudinal cross-sectional view of a female part of a joining piece according to a first alternative of the invention.

FIG. 2 is a diagrammatic longitudinal cross-sectional view of a male part of a joining piece according to the alternative in FIG. 1.

FIG. 3 is a diagrammatic longitudinal cross-sectional view of a joining piece according to the alternative in FIG. 1, the male part being inclined relative to the female part.

FIG. 4 is a perspective view of a joining piece according to the alternative in FIG. 1.

FIG. 5 is a front view of a joining piece according to the alternative in FIG. 1.

FIG. 5A is a longitudinal cross-sectional view of FIG. 5.

FIG. 6 is a diagrammatic longitudinal cross-sectional view of a female part of a joining piece according to a second alternative of the invention.

FIG. 7 is a diagrammatic longitudinal cross-sectional view of a male part of a joining piece according to the alternative in FIG. 6.

FIG. 8 is a diagrammatic longitudinal cross-sectional view of a joining piece according to the alternative in FIG. 6, the male part being inclined relative to the female part.

FIG. 9 is a perspective view of a joining piece according to the alternative in FIG. 6.

FIG. 10 is a front view of a joining piece according to a variant of the alternative in FIG. 6.

FIG. 10A is a longitudinal cross-sectional view of FIG. 10.

FIG. 11 shows a joining piece according to the invention.

FIG. 12 shows a joining piece according to the invention, including coupling flanges, welded to the ends of the male and female parts.

### DETAILED DESCRIPTION

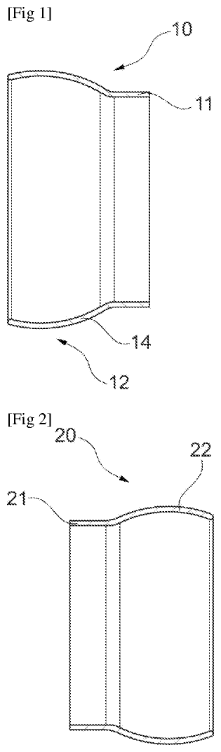

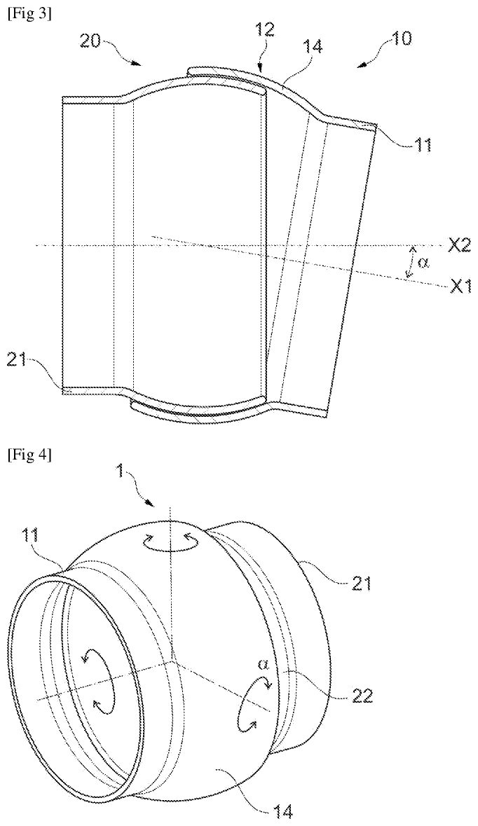

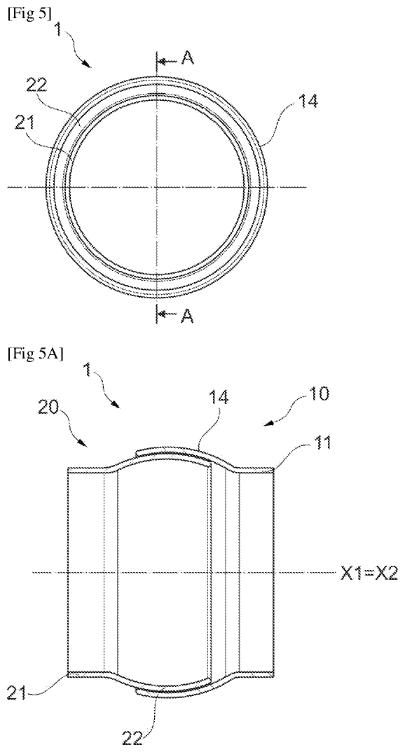

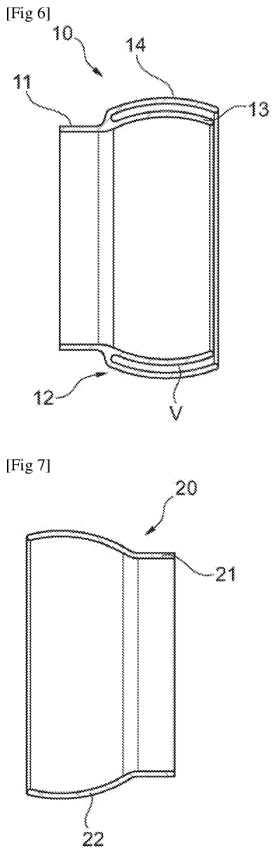

For clarity, the same reference signs denote the same elements both for the alternative of the invention described with reference to FIGS. 1 to 5 and for the alternative described with reference to FIGS. 6 to 10.

A joining piece 1 according to a first alternative of the invention will now be described with reference to FIGS. 1 to 5.

A joining piece 1 according to the invention comprises a female part 10 and a male part 20 mechanically assembled together. In the example shown, the parts 10 and 20 are open-ended in order to permit the circulation of fluid inside the joining piece.

As can be seen more particularly in FIG. 3, the female part 10 has rotational symmetry about an axis X1 and the male part 20 is rotationally symmetrical about an axis X2.

Each of the parts 10, 20 includes a mechanical assembly portion 11, 21 that makes it possible to connect the joining piece to an external element, such as a turbocharger outlet or a motor vehicle combustion engine exhaust line. The mechanical assembly with the external elements can be carried out by welding, bonding or screwing by means of coupling flanges incorporated as set out in detail below.

In the example shown, the mechanical assembly portions 11, 21 can be right cylinders.

The female part 10 also includes an integral receiving portion 12 continuing on from the mechanical assembly portion 11. According to this first alternative of the invention, the receiving portion 12 is made up of a single shell 14 in the shape of an equatorial section of a sphere.

As it is an equatorial section, this section of a sphere is shaped so that the opening of the section of a sphere initially widens from the mechanical assembly portion until it reaches the diameter of the sphere defined by the section of a sphere, and then narrows.

The male part 20 includes an integral insertion portion 22 continuing on from the mechanical assembly portion 21. The insertion portion 22 is made up of a single equatorial section of a sphere, shaped so that the opening of the section widens from the mechanical assembly portion until it reaches the diameter of the sphere defined by the section of a sphere, and then narrows.

The dimensions of the insertion portion 22 and the receiving portion 12 are such that the insertion portion 22 can be inserted with clearance and mechanically retained in the single shell 14 of the female part. The mechanical retention between the two complementary portions 12, 22 allows free rotational movement in all directions between the two parts 10, 20.

The complementary portions 12, 22 are separated by a clearance, the value of which depends particularly on the diameters of the portions 12, 22. The clearance can for example be between 0.02 mm and 0.30 mm.

The female part 10 can, according to a second alternative of the invention, include two shells 13, 14. FIGS. 6 to 10, described below, illustrate this second alternative of the joining piece according to the invention.

A joining piece 1 according to this second alternative comprises a female part 10 and a male part 20 mechanically assembled together. In the example shown, the parts 10 and 20 are open-ended in order to permit the circulation of fluid inside the joining piece.

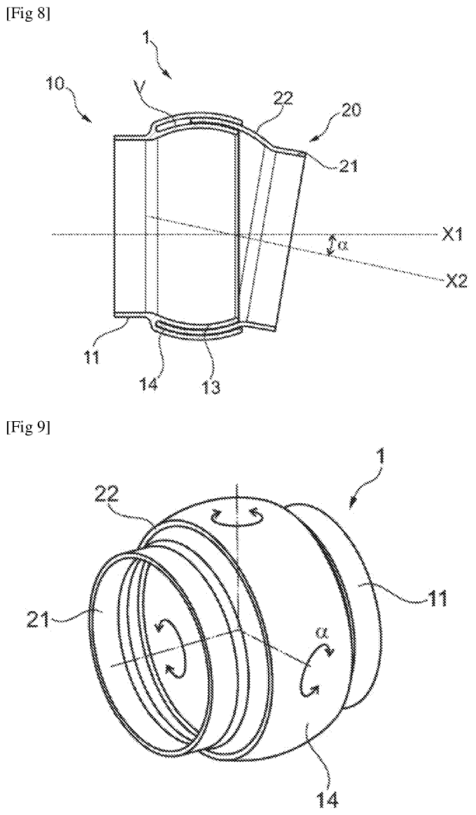

As can be seen more particularly in FIG. 8, the female part 10 has rotational symmetry about an axis X1 and the male part 20 is rotationally symmetrical about an axis X2.

In a similar manner to the first alternative described above, each of the parts 10, 20 includes a mechanical assembly portion 11, 21 that makes it possible to connect the joining piece to an external element, such as a turbocharger outlet or a motor vehicle combustion engine exhaust line. The mechanical assembly with the external elements can be carried out by welding, bonding or screwing by means of coupling flanges incorporated as set out in detail below.

In the example shown, the mechanical assembly portions 11, 21 can be right cylinders.

The female section 10 also includes an integral receiving portion 12 continuing on from the mechanical assembly portion 11. According to this second alternative of the invention, the receiving portion 12 is made up of two shells 13, 14 each in the shape of an equatorial section of a sphere.

As these are equatorial sections, these sections of a sphere are shaped so that the opening of sections of a sphere initially widens from the mechanical assembly portion until it reaches the diameter of the sphere defined by the section of a sphere, and then narrows.

The two equatorial sections of a sphere 13, 14 are concentric and separated by a free space (S).

The male part 20 includes an integral insertion portion 22 continuing on from the mechanical assembly portion 21. The insertion portion 22 is made up of a single equatorial section of a sphere, shaped so that the opening of the section initially widens from the mechanical assembly portion until it reaches the diameter of the sphere defined by the spherical section, and then narrows.

The dimensions of the insertion portion 22 and the receiving portion 12 are such that the insertion portion 22 can be inserted with clearance and mechanically retained in the free space S of the female part. The mechanical retention between the two complementary portions 12, 22 allows free rotational movement in all directions between the two parts 10, 20.

The complementary portions 12, 22 are separated by clearance, the value of which depends particularly on the diameters of the portions 12, 22. The clearance can for example be between 0.02 mm and 0.30 mm.

As a result, in any alternative of the joining piece according to the invention considered, the male part cannot be inserted into and mechanically assembled with the female part if the two parts are manufactured separately. This is due to the shape of the receiving and insertion portions 12, 22.

Thus, to produce the joining piece 1, an additive manufacturing step makes it possible to produce and mechanically assemble the male and female parts of the joining piece according to the invention simultaneously.

Due to the geometry of the complementary parts 10, 20, the assembly thereof obtained directly by additive manufacturing cannot be dismantled.

Advantageously, the design of the joining piece 1 allows the female and male parts 10, 20 to be rotatably mobile relative to each other in all three degrees of freedom: the joining piece according to the invention therefore makes it possible to establish a ball joint between two external elements.

FIGS. 3 and 8 show the piece 1 in the assembled configuration, the male part 20 being inclined by an angle α relative to the female part 10. The male part can rotate through 360° about the axis X1 of symmetry of the female part, but the maximum swivel angle of the male part relative to the female part depends on the geometry of the receiving and insertion portions and can vary depending on the application envisaged.

In the examples shown, the inner and outer diameters of the mechanical assembly portion 11 of the female part 10 are equal to those of the portion 21 of the male part. However, the sections of the portions 11 and 21 can be different, so that either a convergent or a divergent profile is obtained. Depending on the application envisaged, a convergent or divergent profile can be advantageous from the point of view of the dynamics of a fluid circulating through the joining piece.

Advantageously, when the joining piece forms part of a gas circuit such as a combustion engine exhaust line of a motor vehicle, the dynamic sealing of the joining piece is ensured: the inventors have noted the absence of gas leaks to the outside through the clearance between the male part 20 and the female part 10 or through the free space S of the female part 10. This can be explained by the dynamics of the flow of the fluid through the joining piece.

Preferably, in the case of a joining piece as shown in FIGS. 1 to 5 including a female part with a single shell, the gases circulate from the male part 20 towards the female part 10.

Conversely, in the case of a joining piece as shown in FIGS. 6 to 10 including a female part with two shells, the gases preferably circulate from the female part 10 towards the male part 20.

In both cases, the direction of circulation of the gases is such that the gases first enter the part that has the section of a sphere with the smallest diameter. This therefore promotes the dynamic sealing of the joining piece, as the direction of circulation of the gases prevents, or at least limits, the entry thereof into the clearance between the single shell 14 and the insertion portion 22 or into the free space S, depending on the alternative of the invention under consideration.

Static sealing between the male and female parts, without an additional sealing element, can also be envisaged, depending on the application envisaged.

According to the first alternative of the invention in which the female part includes a single shell 14, continuous contact over the entire circumference of the inside of the joining piece can easily be obtained between the outer surface of the insertion portion 22 and the inner surface of the single shell 14 of the receiving portion 12.

This continuous contact makes it possible to obtain static sealing. The contact is for example obtained by applying stress tending to separate the male and female parts from each other, or conversely by applying stress tending to bring the male and female parts closer together. The contact does not prevent the differential rotation of the male and female parts.

Similarly, according to the second alternative of the invention in which the female part includes two shells 13, 14, continuous contact over the entire circumference of the inside of the joining piece can easily be obtained either between the outer surface of the insertion portion 22 and the inner surface of the shell 14 of the receiving portion 12, or between the inner surface of the insertion portion 22 and the outer surface of the shell 13 of the receiving portion 12.

Again, this continuous contact makes it possible to obtain static sealing. The contact is for example obtained by applying stress tending to separate the male and female parts from each other, or conversely by applying stress tending to bring the male and female parts closer together. The contact does not prevent the differential rotation of the male and female parts. Whichever alternative of the invention is considered, the material(s) forming the joining piece according to the invention is/are advantageously selected so that the joining piece withstands temperatures in the region of 1,000° C., usually encountered on combustion engine exhaust lines.

However, depending on the applications envisaged, a joining piece according to the invention can be manufactured using any type of material that can be implemented by additive manufacturing. The selection of the material used can particularly depend on the type of fluid that might be circulating through the joining piece, the temperatures and the pressures to which the joining piece is subject.

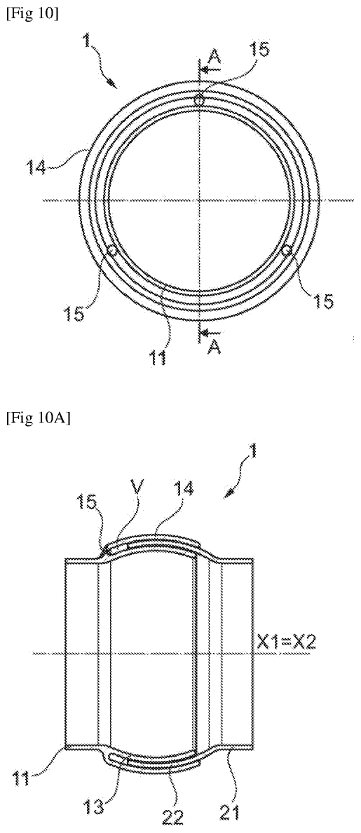

In order to improve the dynamic sealing, it can be envisaged in the scope of the second alternative of the invention to produce one or more through-orifices 15 between the free space S and the outside, as shown in FIGS. 10 and 10A. These through-orifices 15 make it possible to produce a Venturi effect and therefore create to a certain extent a gas stream on the periphery of the joining piece.

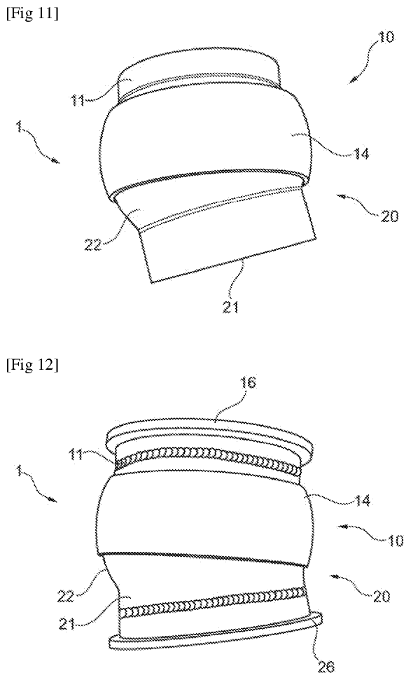

FIG. 11 shows a joining piece according to the invention, for being assembled by welding at the outlet of a turbocharger wastegate.

FIG. 12 shows a joining piece according to the invention that has been assembled using flanges at the outlet of a turbocharger of an internal combustion engine and that has undergone test bed endurance cycles. To produce the flanged assembly, a flange 16, 26 has been welded onto the end of the portion 11 of the female part 10 and the portion 21 of the male part 20 respectively.

The inventors carried out endurance tests on several joining pieces 1, of different diameters, as described above. These pieces 1 were thus assembled using flanges 16, 26 at the turbocharger inlet and outlet and at the wastegate outlet of an internal combustion engine respectively.

The tests, which were performed for several months, revealed that none of the joining pieces 1 according to the invention showed any sign of fatigue or wear, nor deterioration in operation (all of the pieces 1 retained their degrees of freedom and dynamic sealing).

Other variants and alternatives of the invention can be produced without departing from the scope of the invention. The invention is not limited to the examples described above.

Although it is described with reference to the main application envisaged, namely a ball joint in a gas circulation circuit at the outlet of a motor vehicle combustion engine, the invention is also applicable to any field in which it is advantageous to introduce a simple, reliable mechanical joint including one or more degrees of freedom, with or without the circulation of fluid through the joining piece.

1. for producing a mechanical joint between two elements, comprising:
a female part comprising a portion for mechanical assembly with a first element separate from the part, and a receiving portion continuing on from the mechanical assembly portion, the receiving portion comprising a single shell in the shape of an equatorial section of a sphere,
a male part comprising a portion for mechanical assembly with a second element separate from the part, and an insertion portion continuing on from the mechanical assembly portion, the insertion portion being in the shape of an equatorial section of a sphere, inserted with clearance into the shell of the receiving portion and being retained in it, so that the male part is rotatably mobile in one or more degrees of freedom relative to the female part while being mechanically assembled with it.

2. Joining piece for producing a mechanical joint between two elements, comprising:
a female part comprising a portion for mechanical assembly with a first element separate from the part, and a receiving portion continuing on from the mechanical assembly portion, the receiving portion comprising two shells each in the shape of an equatorial section of a sphere, the two equatorial sections of a sphere being concentric and separated by a free space,
a male part comprising a portion for mechanical assembly with a second element separate from the part, and an insertion portion continuing on from the mechanical assembly portion, the insertion portion being in the shape of an equatorial section of a sphere, inserted with clearance into the free space of the receiving portion and being retained in it, so that the male part is rotatably mobile in one or more degrees of freedom relative to the female part while being mechanically assembled with it.

3. Joining piece according to claim 1, one of the receiving portion and the insertion portion also including a slot, the other of the receiving portion and the insertion portion including a pin inserted into the slot, the slot and the pin being configured so that the male part is rotatably mobile in two degrees of freedom relative to the female part.

4. Joining piece according to claim 1, one of the receiving portion and the insertion portion also including a slot, the other of the receiving portion and the insertion portion including a tab that is shorter than the slot and inserted into the slot, the slot and the tab being configured so that the male part is rotatably mobile in one degree of freedom relative to the female part.

5. Joining piece according to claim 1, the amplitude of movement between the female part and the male part, defined by the angle of inclination (α) between the axis of symmetry (X1) of the receiving portion and the axis of symmetry (X2) of the insertion portion, being between 0° and 20°, preferably between 0° and 10°.

6. Joining piece according to claim 1, the mechanical assembly portions of the female part and the male part respectively being cylindrical portions.

7. Joining piece according to claim 1, the mechanical assembly portions of the female part and the male part respectively being truncated cones.

8. Joining piece according to claim 6, the cylindrical portions having identical outer diameters.

9. Joining piece according to claim 1, the male and female parts being open-ended, so that a fluid can circulate inside the joining piece, from one of the mechanical assembly portions towards the other.

10. Joining piece according to claim 6, the male and female parts being open-ended, so that a fluid can circulate inside the joining piece, from one of the mechanical assembly portions towards the other the cylindrical portions having identical inner diameters.

11. Joining piece according to claim 6, the male and female parts being open-ended, so that a fluid can circulate inside the joining piece, from one of the mechanical assembly portions towards the other the cylindrical portions having different inner diameters.

12. Joining piece according to claim 1, the material(s) forming the male part and the female part being suitable for withstanding temperatures of between −50° C. and 1,100° C. and in particular, up to 1,050° C.

13. Joining piece according to claim 1, the material(s) forming the male part and/or female part being selected from any type of weldable material, such as a nickel-based alloy or a stainless steel.

14. Joining piece according to claim 2, one of the receiving portion and the insertion portion also including a slot, the other of the receiving portion and the insertion portion including a pin inserted into the slot, the slot and the pin being configured so that the male part is rotatably mobile in two degrees of freedom relative to the female part, and comprising one or more through-orifices from the outside into the free space.

15. Joining piece according to claim 1, one and/or the other of the portions for mechanical assembly to the first and second element incorporating a coupling flange.

16. Method for manufacturing a joining piece according to claim 1, according to which the female part and the male part are produced and mechanically assembled together in a single step by additive manufacturing.

17. Use of a joining piece according to claim 1 in an exhaust gas circuit at the outlet of an internal combustion engine, particularly of motor vehicle, and/or at the inlet of a motor vehicle turbocharger.
